(19) United States
(12) Patent Application Publication
(10) Pub. No.: US 2019/0227039 A1
(43) Pub. Date: Jul. 25, 2019

(54) SYSTEMS AND METHODS FOR COMPRESSIBLE FLUID CHROMATOGRAPHY

(71) Applicant: Waters Technologies Corporation, Milford, MA (US)

(72) Inventor: Abhijit Tarafder, Blackstone, MA (US)

(73) Assignee: Waters Technologies Corporation, Milford, MA (US)

(21) Appl. No.: 16/206,238

(22) Filed: Nov. 30, 2018

Related U.S. Application Data
(60) Provisional application No. 62/620,241, filed on Jan. 22, 2018.

(51) Int. Cl. G01N 30/32; G01N 30/30; G01N 30/72

(52) U.S. Cl. CPC G01N 30/32; G01N 2030/025; G01N 30/7206; G01N 30/30

(57) ABSTRACT

Exemplary embodiments are directed to methods and systems for managing fluid decompression. A fluid connector is located downstream of a chromatography column and defines an interior bore through which a fluid can pass. The interior bore has a reduced internal diameter at a downstream end compared to an upstream portion of the fluid connector. A cooling system is configured to cool a portion of the fluid connector at or below a threshold temperature value associated with a phase separation of the fluid. A detector is located downstream of the fluid connector, and the detector is configured to receive the fluid exiting the cooled fluid connector.

### RELATED APPLICATIONS

This application claims priority from and the benefit of U.S. Provisional Patent Application No. 62/620,241 filed on Jan. 22, 2018, the entire contents of which are incorporated herein by reference.

### TECHNICAL FIELD

The present disclosure relates to CO₂-based chromatography. More specifically, the present disclosure relates to methods and systems for interfacing such a chromatography system with a mass spectrometer.

### BACKGROUND

Mass spectrometry has commonly been used in conjunction with gas chromatography. However, mass spectrometry is now also commonly employed in conjunction with compressible fluid-based chromatography, referred to as “CFC,” in which a compressible mobile phase, typically compressed carbon dioxide, is used. The term CO₂-based chromatography refers to any chromatographic method in which CO₂ is used in the mobile phase. Typically in CO₂-based chromatography, pressurized and liquefied CO₂ is mixed with liquid organic solvents or mixtures of organic solvents and water. The mixture should be kept under high pressure to maintain mixture integrity. When CFC is coupled with low pressure detectors e.g. Mass spectrometry (MS), the mobile phase needs to be decompressed before it can be introduced to the MS. Control of mobile phase decompression is a significant challenge in CO₂-based chromatography. Decompression of the CO₂-based mobile phase can result in phase separation of the mobile phase in the MS interface, which can lead to formation of distinct liquid and gas phases passing concurrently through the MS interface. Mobile phase decompression can also cause desolvation of analytes carried in the mobile phase as a result of a reduction in solvent density due to depressurization.

The physical properties of a compressible fluid, such as CO₂, are different in the liquid and gas phases. Sample analytes traveling with the liquid phase experiences very different physical interactions compared to sample analytes traveling in the gas phase. The same analyte can be distributed between both phases. As a result, phase separation may lead to chromatographic peak broadening, chromatographic peak splitting, signal loss, and/or other undesirable behaviors.

### SUMMARY

According to an embodiment of the present disclosure, a restrictor with a particular interior geometry, as well as a cooling system, can be used to manage fluid decompression and prevent phase change of various fluid mixtures. In general, embodiments of the present disclosure have improved control over depressurization of the mobile phase carrying the analyte. As a result, the technology described herein allows for improved results when combining mass spectrometry with CFC, especially CO₂-based chromatography.

In one aspect, the present technology relates to a system for managing fluid decompression. The system includes a fluid connector located downstream of a chromatography column and defining an interior bore through which a fluid can pass. The interior bore has a reduced internal diameter at a downstream end compared to an upstream portion of the fluid connector. The system also includes a cooling system configured to cool at least portion of the fluid connector at or below a threshold temperature value associated with a phase separation of the fluid. The system also includes a detector located downstream of the fluid connector and configured to receive the fluid exiting the cooled fluid connector. In one example embodiment, the threshold temperature value is a temperature at which the fluid passing through the fluid connector undergoes phase-separation at a point inside the fluid connector that is 30% from the end of the connector. In another example embodiment, the threshold temperature value is a temperature at which the fluid passing through the fluid connector undergoes phase-separation at a point inside the fluid connector that is 20% from the end of the connector. In another example embodiment, the threshold temperature value is below −25° C. In another example embodiment, the fluid is a mixture of CO₂ and methanol. In another example embodiment, the fluid connector is a restrictor configured to control a pressure change of the fluid. In another example embodiment, the internal diameter of the interior bore of the fluid connector is between about 0.1 microns and about 100.0 microns at the downstream end. In another example embodiment, the cooling system is configured to cool at least a portion of the fluid connector in response to decreasing or increasing signal from the detector.

In another aspect, the present disclosure relates to a method of managing fluid decompression. The method includes determining a threshold temperature value associated with a phase separation of a fluid, cooling a portion of a fluid connector located downstream of a chromatography column to a temperature at or below the threshold temperature value, and directing the fluid through the interior bore of the cooled fluid connector to a detector. The fluid connector defines an interior bore through which the fluid can pass, and the interior bore has a reduced internal diameter at a downstream end compared to an upstream portion of the fluid connector. In one example embodiment, determining the threshold temperature value includes retrieving phase separation temperature data corresponding to the fluid from a database. In another example embodiment, the threshold temperature value is a temperature at which the fluid passing through the fluid connector undergoes phase-separation at a point inside the fluid connector that is 30% from the end of the connector. In another example embodiment, the threshold temperature value is a temperature at which the fluid passing through the fluid connector undergoes phase-separation at a point inside the fluid connector that is 20% from the end of the connector. In another example embodiment, the threshold temperature value is below −25° C. In another example embodiment, the method also includes providing a feedback loop from the detector to a cooling system; and cooling at least a portion of the fluid connector in response to decreasing or increasing signal from the detector. In another example embodiment, the fluid is a mixture of CO₂ and methanol. In another example embodiment, the fluid connector is a restrictor configured to control a pressure change of the fluid. In another example embodiment, the internal diameter of the interior bore of the fluid connector is between about 0.1 microns and about 100.0 microns at the downstream end.

In another aspect, the present disclosure relates to a system for managing fluid decompression between a CO₂-based chromatography column and a detector. The system includes a CO₂-based chromatography column. The system also includes a fluid connector located downstream of the CO₂-based chromatography column and configured to receive a fluid containing CO₂ from the CO₂-based chromatography column. The fluid connector defines an interior bore through which the fluid can pass and has a reduced internal diameter at a downstream end compared to an upstream portion of the fluid connector. The system also includes a detector located downstream of the fluid connector and configured to receive the fluid exiting the fluid connector. The system also includes a cooling system operatively coupled to the fluid connector and configured to cool at least a portion of the fluid connector at or below a threshold temperature value to minimize phase separation of the fluid within the fluid connector. In one example embodiment, the phase separation is delayed until the end of the fluid connector.

The above aspects of the technology provide numerous advantages. For example, the techniques described herein can prevent or delay phase change of a fluid due to mobile-phase depressurization within a fluid connector at an interface with a mass spectrometer.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a schematic of a scheme of interfacing CO₂-based chromatography with MS, according to the prior art.

FIG. 2 illustrates isenthalpic curves and isopycnic (constant density) curves of pure CO₂.

FIG. 3 is a graph representing the region in which both vapor and liquid phases are present for CO₂ with 5% methanol, according to an embodiment of the present disclosure.

FIG. 4 is a graph representing the region in which both vapor and liquid phases are present for a 70/30 mol/mol % mixture of CO₂ and methanol, according to an embodiment of the present disclosure.

FIGS. 5A-5C illustrate example connector geometries, according to various embodiments of the present disclosure.

FIGS. 6A-6E illustrate additional example connector geometries, according to embodiments of the present disclosure.

FIG. 7 shows a cross-sectional view of an example capillary restrictor with a cooling system, according to an embodiment of the present disclosure.

FIG. 8 is an example flowchart of a method for managing fluid decompression, in accordance with an embodiment of the present disclosure.

### DESCRIPTION OF EXEMPLARY EMBODIMENTS

In general, the present technology is related to systems and methods for managing or controlling fluid decompression in a chromatography system. According to one embodiment, the present disclosure relates to methods and systems for interfacing CO₂-based fluid chromatography with mass spectrometry.

As noted above, temperature modulation of a chromatography-MS interface can be used to prevent phase separation during solvent decompression. Conventional theory suggests that increasing temperature of the mobile phase is effective because the temperature increase also increases the solvation power of the mobile phase. However, increasing temperature actually decreases solubility when the pressure is below the solubility inflection point (“SIP”). For example, the solubility of fluorene was measured and reported at various pressure temperature conditions, as shown in Bartle et al.; Measurement of Solubility in Supercritical Fluids Using Chromatographic Retention; J. Chem. Eng. Data 1990, 35, 355-360. The value of SIP is different for different compounds but is typically more than 1500 psi. During the process of decompression in the MS interface, the pressure is typically less than 1500 psi. At such pressures, an increase in temperature will decrease solubility. Increasing the temperature of the chromatography-MS interface region, however, may prevent phase separation of the mobile phase under certain conditions. When the compressible mobile phase, e.g., CO₂, includes a modifier, e.g., an organic modifier such as methanol, increasingly higher temperature is necessary to avoid phase separation determined by the composition of methanol in the CO₂+methanol mixture.

At the capillary scale, in which the mobile phase is mostly pure CO₂, heating the mobile-phase entering MS can be helpful. See, e.g., R. D. Smith, H. R. Udseth, Mass spectrometry with direct supercritical fluid injection, 442 Anal. Chem. 55 (1983) 2266-2272 (“Smith”). For example, Smith suggests that a fluid temperature of at least 80 to 100 C before entering the connector/restrictor should be maintained to avoid a two phase region during CO₂ expansion.

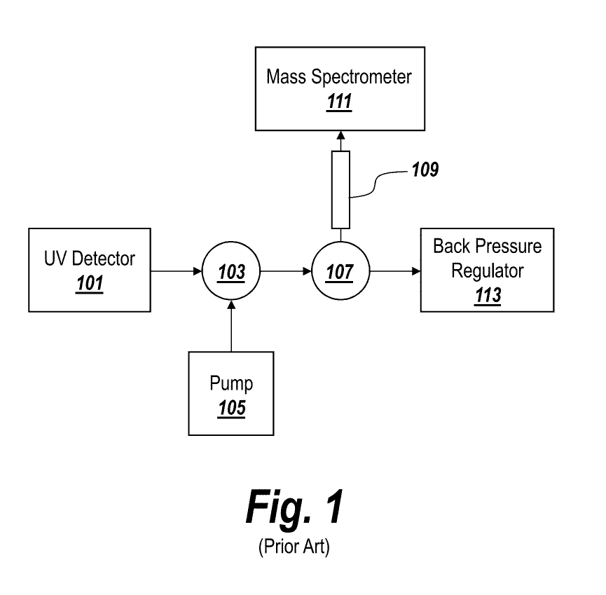

FIG. 1 is a schematic of a scheme of interfacing CO₂-based chromatography with MS, according to the prior art. The output of the UV detector 101 goes to a tee/mixer 103 where makeup fluid is mixed from a pump 105. The mixed stream heads to a second tee/splitter 107 where a minor portion of the stream is led to the mass spectrometer 111, whereas the majority is led to a back pressure regulator 113. The tubing from the second tee/splitter 107 to the mass spectrometer 111 can be covered with an insulating sleeve 109. Heating of the interface region between the mass spectrometer 111 and the rest of the system may prevent a phase-separation during the solvent decompression process occurring within the interface.

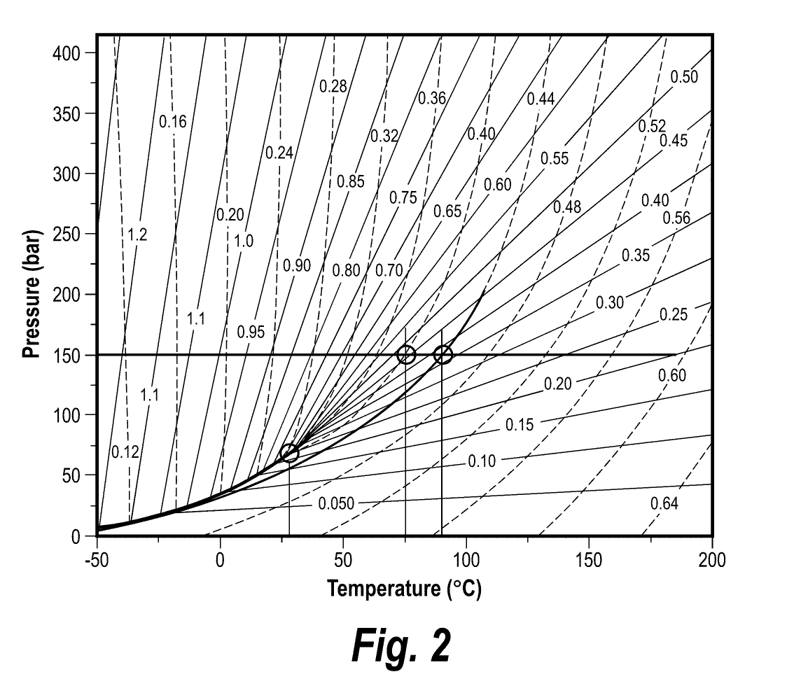

FIG. 2 illustrates isenthalpic curves and isopycnic (constant density) curves of pure CO₂. Isenthalpic units are the enthalpy value in kJ/g and isopycnic units are the density g/mL. FIG. 2 also shows the phase boundary of a pure CO₂ mixture. The isenthalpic curve of 0.44 kJ/g provides a boundary of an exemplary minimum temperature of a chromatography-MS interface connector to avoid any phase separation during the decompression process under any circumstances. For example, at 150 bar, following the boundary of 0.44 kJ/g, the minimum starting temperature of the MS-bound fluid should be 88 C. If the temperature is less than that, during a decompression process, the fluid temperature will decrease following the isenthalpic curve and end-up at a pressure-temperature combination where liquid CO₂ will start precipitating out of the fluid. This observation assumes that the depressurization is taking place under adiabatic condition. For better understanding of this observation see ref. Tarafder A, Iraneta P, Guiochon G, Kaczmarski K, Poe DP, J Chromatography A. 2014 1366: 126-35, the contents of which is incorporated by reference in its entirety. For another example, if the temperature chosen is 75 C, CO₂ will turn a two-phase mixture when the pressure drops down to 70 bar which makes the temperature drop down to 28 C. In the preceding examples, the temperature is assumed to drop isenthalpically following a depressurization. In reality, the temperature drop will not be that sharp. If a heating sleeve is employed to heat-up the MS interface it may help to maintain a temperature closer to the heater temperature. However, the chosen boundary ensures that if a higher temperature is chosen then under no conditions the fluid will enter a two-phase regime while being depressurized.

In one example embodiment, the present disclosure teaches an approach in which the mobile phase in a CO₂-based fluid chromatography system is cooled to improve performance when interfacing with a mass spectrometry system. For example, cooling the mobile phase can help prevent phase separation of the mobile phase, e.g., CO₂, and has other benefits, as described in more detail below.

A mobile phase including CO₂ and liquid organic co-solvent(s)—commonly methanol and some other additive, can be used in some example embodiments. Apart from adding co-solvent(s), another stream of liquid organic solvent (commonly methanol and some other additive) can be mixed to the mobile-phase during the chromatography-MS analysis, after it exits the column. This stream is called a make-up fluid which is added to facilitate chromatography-MS interfacing. The primary purpose of the make-up fluid is to help the MS-bound mobile-phase to dissolve the less volatile compounds which could be precipitating out of solution during the depressurization process. Addition of the co-solvents, however, also changes the phase-diagram of the mobile-phase. For example, the range of conditions that may lead to separation of a single-phase into two different phases increases when methanol is added to CO₂.

When a liquid organic co-solvent is added to CO₂-based fluid chromatography, or a liquid organic solvent is added as a make-up fluid to chromatography-MS interface, net percent of liquid increases in the solvent which is going towards the MS. If this solvent is not depressurized properly, there may be a phase separation somewhere inside the connecting tube. Similar to the example described with pure CO₂, even with CO₂ and liquid solvent mixtures, the conventional solution may be to heat up the solvent mixture.

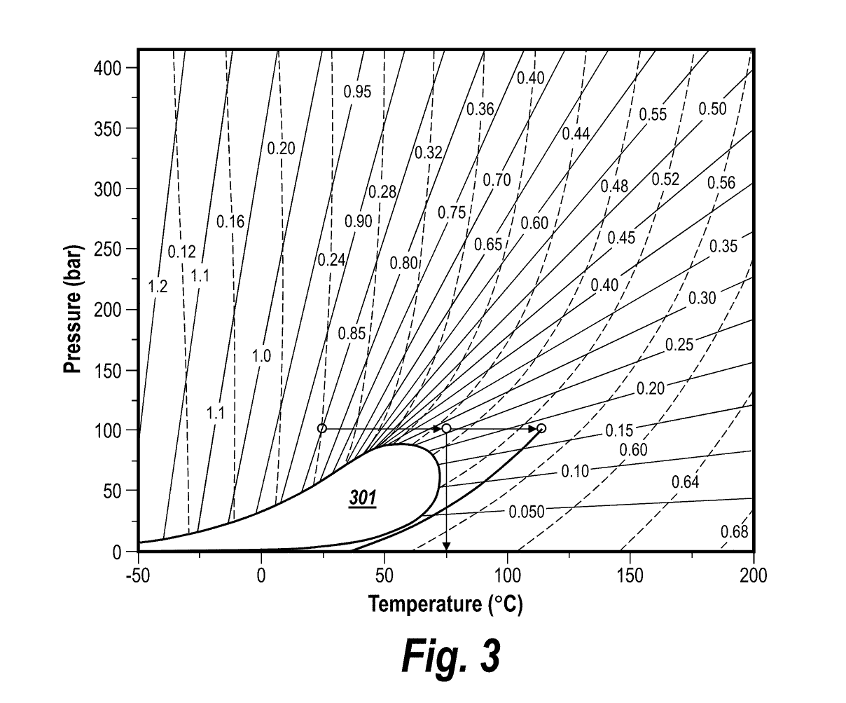

FIG. 3 is a graph showing an area 301 on the phase diagram representing the region in which both vapor and liquid phases are present for CO₂ with 5% methanol, according to an embodiment of the present disclosure. As shown, the addition of liquid co-solvent to CO₂ significantly increases the number of pressure-temperature combinations where a homogenous phase separates into a vapor and a liquid phase. With an increasing percent of modifier in CO₂, the area (and hence the pressure-temperature conditions) of solvent de-mixing increases to a certain percentage and then decreases. When more modifier is added to mobile-phase having lower percent of modifiers (e.g. 1 to 30%) the area of solvent de-mixing increases.

FIG. 3 illustrates the phase boundary of a CO₂ and methanol mixture of 95/05 (mol/mol,%) composition and includes contours of constant density curves and constant enthalpy or isenthalpic curves. Isenthalpic units are the enthalpy value in kJ/g and isopycnic units are the density g/mL. This example graph also shows the phase boundary of the CO₂ and methanol mixture. At 100 bar, if the MS interface temperature is increased from 25° C. to 75° C., the solvent will enter the two-phase region if the solvent starts depressurizing without any exchange of heat with the surroundings (isenthalpic). If the depressurization can be conducted under isothermal conditions (shown by the straight line connecting 100 bar and 1 bar at 75° C.), phase separation inside the connecting tube can be avoided. If depressurization is done under isenthalpic conditions, the temperature must be increased to nearly 120° C. to ensure that the mixture never enters the two-phase region.

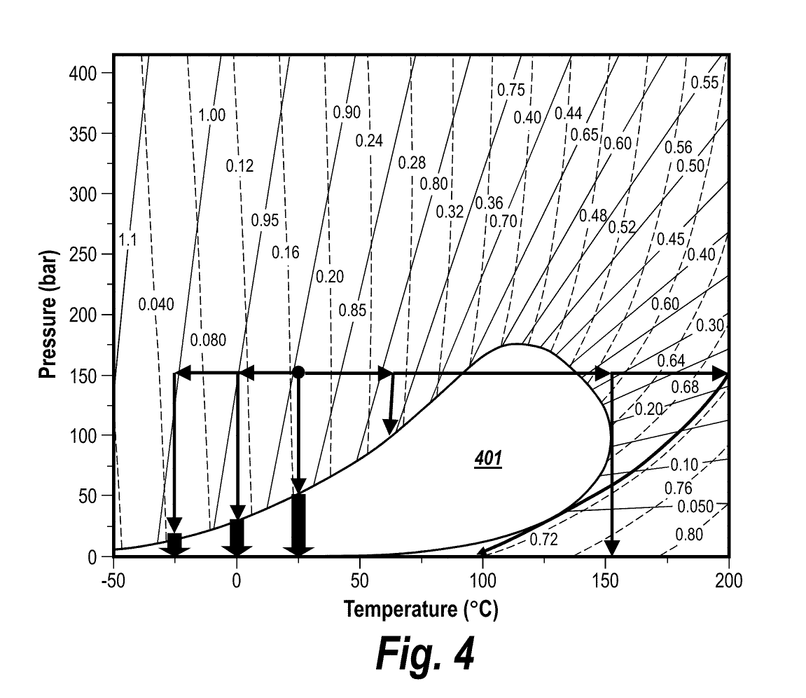

FIG. 4 is a graph showing an area 401 on a phase diagram representing the region in which both vapor and liquid phases are present for a 70/30 mol/mol % mixture of CO₂ and methanol, according to an embodiment of the present disclosure. As shown, the increase in methanol percentage can increase the size of the area in which both vapor and liquid phases are present for CO₂, as compared to FIG. 3.

FIG. 4 illustrates the phase boundary of a CO₂ and methanol mixture of 70/30 (mol/mol,%) composition and includes contours of constant density curves and constant enthalpy or isenthalpic curves. Isenthalpic units are the enthalpy value in kJ/g and isopycnic units are the density g/mL. This example embodiment shows that at 150 bar, if the MS interface temperature is increased from 25° C. to 100° C., the solvent will enter the two-phase region even before the solvent starts depressurizing. If the MS interface temperature is increased from 25° C. to 75° C., the solvent will enter the two-phase region almost immediately after the solvent starts depressurizing. To avoid entering a two-phase region, the interface can be heated beyond 150° C. for the mobile phase composition, i.e., CO₂ and methanol mixture of 70/30 (mol/mol,%). At 150° C., to avoid phase-separation, the temperature should be maintained constant throughout the interface length. If the depressurization process is isenthalpic, i.e. no exchange of heat between the interface and the surroundings is allowed, the temperature should be increased to nearly 200° C. to ensure that the mixture never enters the two-phase region.

According to one embodiment of the present disclosure, phase separation of the mobile phase can be prevented by cooling the mobile phase, rather than heating it. For example, FIG. 4 illustrates that cooling the mobile phase to 0° C. permits depressurization from 150 bar to as low as 25 bar before entering the two-phase region. For the conditions illustrated in FIG. 4, the two phase region can be avoided at temperatures less than 0° C. for final pressures higher than 25 bar.

In a non-limiting example embodiment, phase separation can further be prevented by providing a sharp pressure drop across the tip of the connector. For lower temperatures, the pressure-drop requirement at the connector tip can be reduced. For example, at −30° C., the pressure would only need to be reduced by 12 bar to avoid phase separation inside the connector. Furthermore, the boundaries of the two phase region are more consistent between varying solvent compositions, e.g., percentage of modifier, at lower temperature ranges than at higher temperature ranges. As a result, the depressurization or interface temperature does not need to be modified dynamically as modifier percentage changes, e.g., during a gradient separation. Also, with increasing percent of modifier/co-solvent, the numerical value of pressure-drop across the connector tip increases because of increasing viscosity of the mobile-phase. In other words, increasing percent of co-solvent at a fixed low temperature (e.g. 0 C) decreases the possibility of phase-separation inside a pinched-tip connector. For better understanding of the situation see ref. [Tarafder, Journal of Chromatography B 1091 (2018) 1-13] the contents of which is incorporated by reference in its entirety.

A further advantage of cooling is that solvent density changes can be minimized, even during depressurization such that the problem of analyte desolvation is also reduced. At higher temperatures, during depressurization, solvent density typically reduces from 4 to 7 fold. At lower temperatures, under a similar drop in pressure, solvent density reduces by only a few percentages.

According to some embodiments, connector geometry can play a role in the decompression process. A long connector, with a high length to diameter ratio (high aspect ratio), which leads to continuous, gradual, linearly reducing pressure inside the connector, and therefore gradual reduction in solvent density, should be avoided. If the phase separation occurs when depressurizing through such a gradual connector, the negative effects of depressurization and the phase change are imparted over a longer distance of the connector. This can lead to unstable or erratic spraying exiting the connector. On the other hand, a relatively short connector with a wide diameter but a sharply tapered or pinched end can limit the pressure drop and the phase change to the very end or tip of the connector, thus limiting the negative effects of depressurization and phase change.

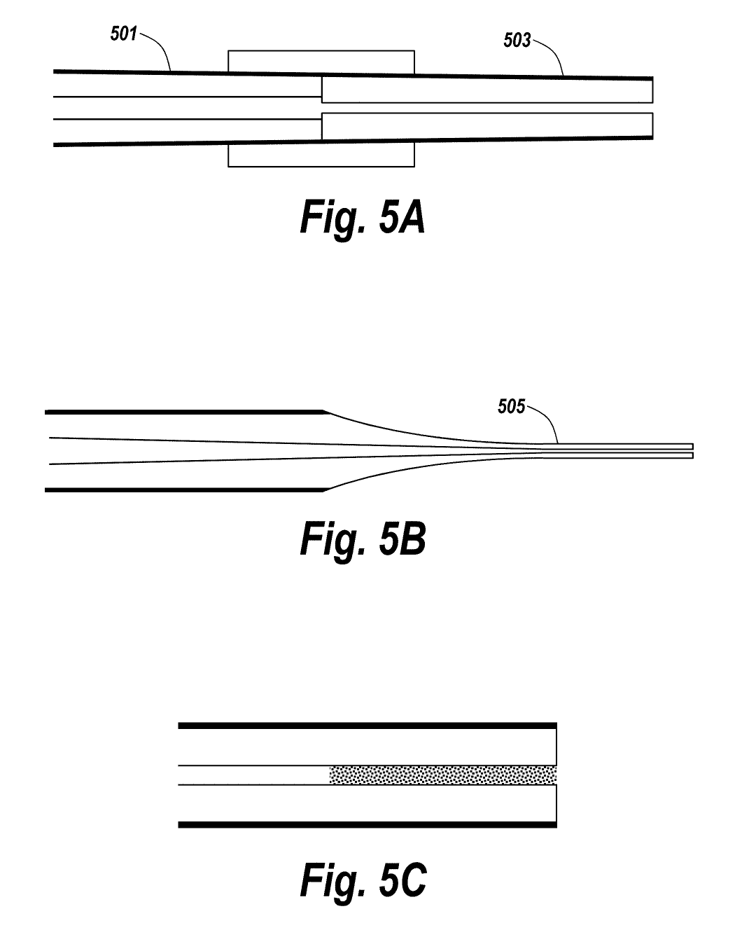

FIGS. 5A-5C illustrate example connector geometries, according to various embodiments of the present disclosure. FIG. 5A shows a cross-sectional view of a linear capillary restrictor having a larger internal diameter at an upstream section 501 and a smaller internal diameter at a downstream section 503. As long as the downstream section 503 is not too long, and the upstream section 501 does not offer strong flow resistance, this design can help contain the depressurization at or near the exit of the connector. FIG. 5B shows a cross-sectional view of a tapered capillary restrictor. This example restrictor has an internal diameter that gradually decreases as it nears a tapered exit portion 505. Such a restrictor can be more fragile than the one shown in FIG. 5A, and has a less favorable aspect ratio. FIG. 5C shows a cross-sectional view of a porous frit capillary restrictor packed with sub-micron particles. Such geometry results in multiple fluidic paths with very high aspect ratios. This example geometry can improve transport of relatively volatile compounds, but may not be efficient for nonvolatile compounds.

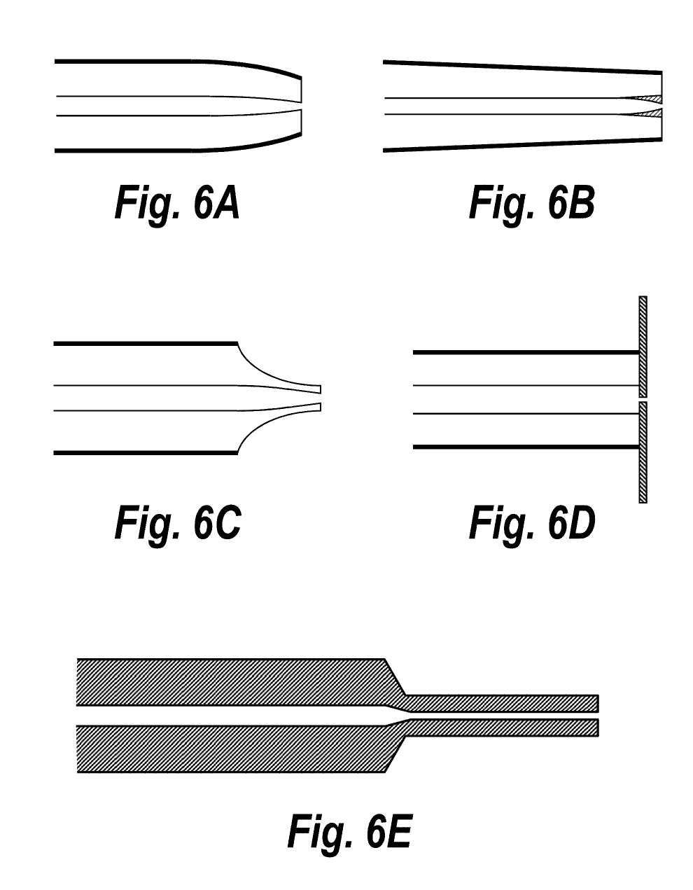

FIGS. 6A-6E illustrate additional example connector geometries, according to embodiments of the present disclosure. FIG. 6A shows a cross-sectional view of a capillary restrictor fabricated by polishing the closed end of the capillary until a small orifice of a required diameter is obtained. FIG. 6B shows a cross-sectional view of a capillary restrictor fabricated by internally depositing a material in order to nearly close the exit. FIG. 6C shows a cross-sectional view of a capillary restrictor similar to the one shown in FIG. 5B, but with an improved aspect ratio. FIG. 6D shows a cross-sectional view of a capillary restrictor with a diaphragm or pinhole orifice. The orifice can be laser drilled, in some embodiments. FIG. 6E shows a cross-sectional view of a pinched capillary restrictor fabricating by crimping an end portion (e.g., the last 1 mm) of a segment of platinum-iridium tubing. In this example embodiment, the platinum-iridium tubing has an internal diameter between about 50-100 pm. One skilled in the art will appreciate that the restrictors can be made from fused silica or various types of metals. As discussed above, the decreased exit diameters of these restrictors can limit the depressurization and any associated phase changes to a smaller portion of the restrictor near the exit.

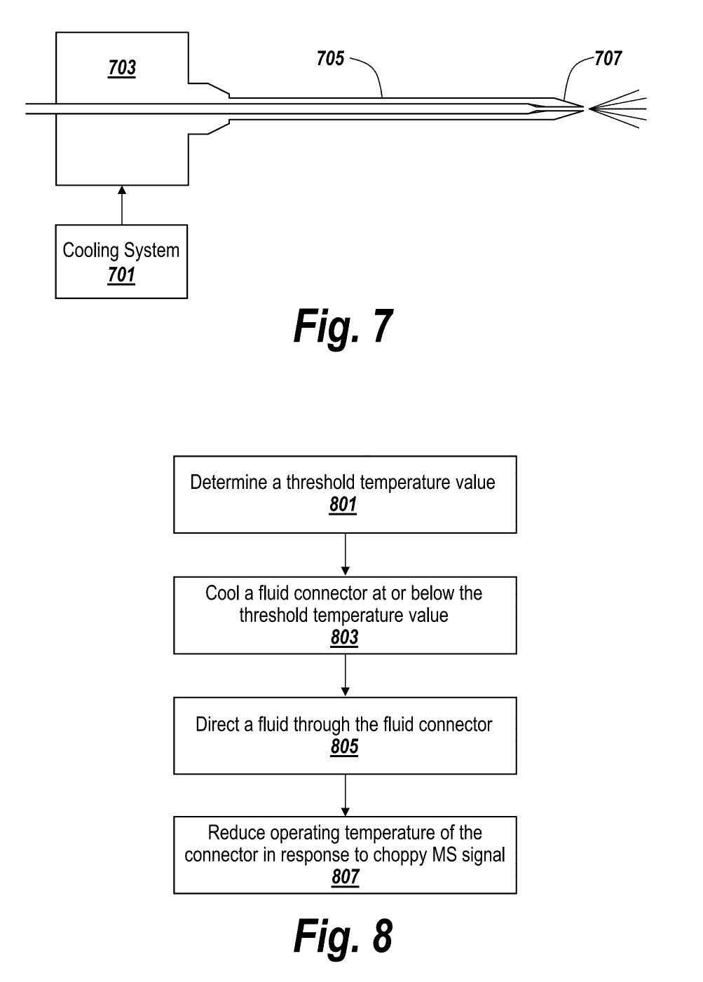

FIG. 7 shows a cross-sectional view of an example capillary restrictor with a cooling system, according to an embodiment of the present disclosure. In this example embodiment, the capillary restrictor 703 is operatively coupled with a cooling system 701 which can cool the various portions of the restrictor to a desired temperature. The restrictor includes a capillary portion 705, as well as a downstream portion 707 that has a smaller internal diameter than the rest of the restrictor. As discussed above, the decompression of the fluid, as well as any associated phase change, can be limited to the end of the restrictor if the interior diameter of the downstream portion 707 is sufficiently small. This narrow exit diameter, along with the cooling system 701, can help prevent phase separation as discussed above in reference to FIG. 4.

FIG. 8 is an example flowchart of a method for managing fluid decompression, in accordance with an embodiment of the present disclosure. In step 801, a threshold temperature value associated with a phase separation of a fluid is determined. The fluid can be, in some embodiments, a mixture of CO₂ and methanol at various proportions. In a non-limiting example, determining the threshold temperature value includes retrieving phase separation temperature data corresponding to the fluid from a database. Based on this phase separation temperature data, the system can know what temperature should be maintained in order to prevent a phase separation within a capillary restrictor, in some embodiments. In a non-limiting example, the threshold temperature value is a temperature at which the fluid passing through the fluid connector undergoes phase-separation at a point inside the fluid connector that is 30% from the end of the connector. In another non-limiting example, the threshold temperature value is a temperature at which the fluid passing through the fluid connector undergoes phase-separation at a point inside the fluid connector that is 20% from the end of the connector. In yet another non-limiting example, the threshold temperature value is below −25° C.

In step 803, a portion of a fluid connector located downstream of a chromatography column is cooled to a temperature at or below the threshold temperature value. In one example embodiment, the fluid connector defines an interior bore through which the fluid can pass, and the interior bore has a reduced internal diameter at a downstream end compared to an upstream portion of the fluid connector. In a non-limiting example, the fluid connector is a restrictor configured to control a pressure change of the fluid. In another non-limiting example, the internal diameter of the interior bore of the fluid connector is between about 0.1 microns and about 100.0 microns at the downstream end.

In step 805, the fluid is directed through the interior bore of the cooled fluid connector to a detector. The detector can be a mass spectrometer, in some embodiments. As discussed above, limiting decompression and phase changes within the fluid can help improve the functionality of the detector and provide better detector results.

In step 807, the operating temperature of the fluid connector is reduced in response to degrading MS signal below an acceptable value or criterion. As discussed above in reference to FIG. 4, once the fluid connector is cooled, the pressure of the fluid can also be reduced while still preventing or reducing decompression or phase change of the fluid passing through the restrictor or connector. This is because at lower temperatures, the two-phase portion of the fluid mixture can be reduced even at lower pressure values. This can provide a significantly more robust system by not subjecting the fluid connector to such high pressure values, while also preventing damage to the connector caused by fluid depressurization. Setting lower temperatures for the MS interface allows the fluid to stay as a homogenous mixture, without phase separating, at much lower pressures. For example, at 50 C, the fluid inside the MS interface may start phase-separating when the pressure reaches 50 bar. Whereas, at 0 C, the fluid can depressurize until 25 bar without experiencing a phase separation. In one example embodiment, a feedback loop from the MS can be provided to automatically control the MS interface temperature in response to decreasing or increasing MS signal.

As mentioned above, the solubility of fluorine, for example, varies as a function of pressure and temperature (see Bartle et al.; Measurement of Solubility in Supercritical Fluids Using Chromatographic Retention; J. Chem. Eng. Data 1990, 35, 355-360). Specifically, above 140 bar (2030 psi) increasing temperature increases solubility, whereas below 140 bar increasing temperature decreases solubility.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A system for managing fluid decompression comprising:
a fluid connector located downstream of a chromatography column and defining an interior bore through which a fluid can pass, the interior bore having a reduced internal diameter at a downstream end compared to an upstream portion of the fluid connector;
a cooling system configured to cool at least a portion of the fluid connector at or below a threshold temperature value associated with a phase separation of the fluid; and
a detector located downstream of the fluid connector, the detector configured to receive the fluid exiting the cooled fluid connector.

2. The system of claim 1, wherein the threshold temperature value is a temperature at which the fluid passing through the fluid connector undergoes phase-separation at a point inside the fluid connector that is 30% from the end of the connector.

3. The system of claim 1, wherein the threshold temperature value is a temperature at which the fluid passing through the fluid connector undergoes phase-separation at a point inside the fluid connector that is 20% from the end of the connector.

4. The system of claim 1, wherein the threshold temperature value is below −25° C.

5. The system of claim 1, wherein the fluid is a mixture of CO₂ and methanol.

6. The system of claim 1, wherein the fluid connector is a restrictor configured to control a pressure change of the fluid.

7. The system of claim 1, wherein the internal diameter of the interior bore of the fluid connector is between about 0.1 microns and about 100.0 microns at the downstream end.

8. The system of claim 7, wherein the phase separation is delayed until the end of the fluid connector.

9. The system of claim 1, wherein the cooling system is configured to cool at least a portion of the fluid connector in response to decreasing or increasing signal from the detector.

10. A method of managing fluid decompression comprising:
determining a threshold temperature value associated with a phase separation of a fluid;
cooling a portion of a fluid connector located downstream of a chromatography column to a temperature at or below the threshold temperature value, wherein the fluid connector defines an interior bore through which the fluid can pass, the interior bore having a reduced internal diameter at a downstream end compared to an upstream portion of the fluid connector; and
directing the fluid through the interior bore of the cooled fluid connector to a detector.

11. The method of claim 10, wherein determining the threshold temperature value includes retrieving phase separation temperature data corresponding to the fluid from a database.

12. The method of claim 10, wherein the threshold temperature value is a temperature at which the fluid passing through the fluid connector undergoes phase-separation at a point inside the fluid connector that is 30% from the end of the connector.

13. The method of claim 10, wherein the threshold temperature value is a temperature at which the fluid passing through the fluid connector undergoes phase-separation at a point inside the fluid connector that is 20% from the end of the connector.

14. The method of claim 10, wherein the threshold temperature value is below −25° C.

15. The method of claim 10, further comprising:
providing a feedback loop from the detector to a cooling system; and
cooling at least a portion of the fluid connector in response to decreasing or increasing signal from the detector.

16. The method of claim 10, wherein the fluid is a mixture of CO₂ and methanol.

17. The method of claim 10, wherein the fluid connector is a restrictor configured to control a pressure change of the fluid.

18. The method of claim 10, wherein the internal diameter of the interior bore of the fluid connector is between about 0.1 microns and about 100.0 microns at the downstream end.

19. A system for managing fluid decompression between a CO₂-based chromatography column and a detector, the system comprising:
a CO₂-based chromatography column;
a fluid connector located downstream of the CO₂-based chromatography column and configured to receive a fluid containing CO₂ from the CO₂-based chromatography column, the fluid connector defining an interior bore through which the fluid can pass and having a reduced internal diameter at a downstream end compared to an upstream portion of the fluid connector;
a detector located downstream of the fluid connector and configured to receive the fluid exiting the fluid connector; and
a cooling system operatively coupled to the fluid connector and configured to cool at least a portion of the fluid connector at or below a threshold temperature value to minimize phase separation of the fluid within the fluid connector.

20. The system of claim 19, wherein the phase separation is delayed until the end of the fluid connector.
